(19) United States
(12) Patent Application Publication
(10) Pub. No.: US 2010/0173353 A1
(43) Pub. Date: Jul. 8, 2010

(54) Lysis Reagent Formulation

(75) Inventors: Stephanie Koennings, Bottmingen (CH); Leif Kuhler, Lucern (CH); Eberhard Russmann, Penzberg (DE); Katja Schuster, Malters (CH); Edward S. Smtih, San Francisco, CA (US)

Correspondence Address: Roche Molecular Systems, Inc.;Patent Law Department, 4300 Hacienda Drive, Pleasanton, CA, 94588, US

(73) Assignee: ROCHE MOLECULAR SYSTEMS, INC., Pleasanton, CA (US)

(21) Appl. No.: 12/499,548

(22) Filed: Jul. 8, 2009

(30) Foreign Application Priority Data
Jul. 9, 2008 (EP) EP08104690.6

(51) Int. Cl. G01N 1/28

(52) U.S. Cl. 435/40.5

(57) ABSTRACT

Subject matter of the invention is a lysis reagent formulation for binding components of a sample in the form of a tablet comprising a multitude of magnetic particles which are held together with the aid of excipients, a chaotropic salt and an excipient and the use of this lysis reagent formulation in analytical tests.

### CROSS-REFERENCES TO RELATED APPLICATIONS

The present application claims the benefit of a European Application No. 08104690.6 filed on Jul. 9, 2008.

### FIELD OF THE INVENTION

The present invention relates to an improved lysis reagent formulation for binding components in a sample in the form of a tablet comprising a multitude of particles having a surface to which the components can essentially completely bind and excipients.

### SUMMARY OF THE INVENTION

Subject matter of the invention is a lysis reagent formulation in the form of a tablet comprising magnetic particles and a lysis reagent for binding components of a sample, the use thereof for binding or purifying nucleic acids and a method of preparing a lysis reagent formulation in the form of a tablet comprising magnetic particles and a lysis reagent.

### BRIEF DESCRIPTION OF THE FIGURES

FIG. 1 Assay performance with tablet in DWP

### DETAILED DESCRIPTION OF THE INVENTION

Magnetic particles are commonly used to purify analytes from biological samples such that they can be subsequently analysed. Tablets of magnetic particles for purification of analytes have been described which additionally comprise reagents necessary for lysing cells and/or microorganisms in biological samples.

Components are understood to be particulate or molecular material. This includes especially cells, e.g. viruses or bacteria, but also isolated human or animal cells such as leukocytes, then also immunologically active low and high molecular chemical compounds such as haptens, antigens, antibodies, and nucleic acids. Particularly preferred are nucleic acids such as DNA or RNA.

Samples as understood in the invention are for example clinical specimen such as blood, serum, plasma, mouth wash liquid, urine, liquid cytology media, cerebrospinal fluid, sputum, stool, punctate, and bone marrow samples. The sample can also stem from areas such as environmental analysis, food analysis or molecular-biological research, e.g. bacterial cultures, phage lysates, and products of amplification processes such as PCR.

A tablet as understood in the invention is a solid, formed body, preferably in the form of a disk or a more or less perfectly shaped sphere. The term “sphere” as used herein also encompasses oblong or oval forms. Other similar embodiments are also conceivable. Tablets of this kind are commonly known from active pharmaceutical ingredients. A tablet preferably has a defined weight which exceeds 5 mg.

A magnetic particle is a particle made of a material which can be attracted by a magnet, i.e. ferromagnetic or superparamagnetic materials. The invention prefers in particular superparamagnetic particles, especially those that are not premagnetized. Premagnetization as understood here is a process of bringing a material into contact with a magnet to increase resonance. Magnetide (Fe₃O₄) or Fe₂O₃ are particularly preferred. A magnetic particle is, however, also understood to include materials which contain (smaller) magnetic particles. This includes in particular Iriodin 600 a pigment which is commercially available from Merck (Darmstadt, Germany). The invention prefers in particular particles with an average grain size of less than 100 μm. A particularly preferred grain size ranges between 10 and 60 μm. The preferred grain distribution is relatively homogeneous; in particular, there are almost no particles smaller than 10 μm or larger than 60 μm. Particles which satisfy this requirement are described for example in WO 90/06045.

An essential element of the invention is the fact that magnetic particles have a surface to which components can bind. This binding can either be specific or relatively non-specific. Specific binding can be achieved by making use of a binding-specific interactions, e.g. antibodies and antigens, antibodies and haptens or complementary nucleic acids. A combination of these interactions is also possible.

A known method of modifying a surface is, for example, the coating of particles with a streptavidin layer. It is thus possible to generate a universal matrix to which specific components can be bound from the sample via conjugates of biotin and a certain antibody, hapten or nucleic acid. The expert, especially one from the field of immunoassays, is familiar with corresponding embodiments.

A relatively unspecific binding is the interaction between a glass-like surface and nucleic acids. The binding of nucleic acids from agarose gel in the presence of sodium iodide in ground flint glass is known from Proc Natl Acad USA 76, 615-619 (1979). U.S. Pat. No. 2,233,169 describes magnetic particles whose glass portion can bind nucleic acids.

The invention proposes that the component to be determined bind essentially completely to the magnetic particles. The expert can easily determine the necessary amount of particles by varying the amount of magnetic particles to be added. As understood in the invention, an essentially complete binding means binding of more than 60%, particularly preferred more than 90% of the component to be bound found in the sample.

Magnetic particles, especially those with a glass surface, can be stored in the form of a tablet without visible hydrolysis of the glass and hence without visible elution of the iron from the magnetic portion.

The magnetic particles are preferably glass magnet pigments or polymer magnetic beads or other magnetic particles with a size ranging between 0.1 μm and 100 μm; e.g. those described in DE 19520390.

The formulation can also contain excipients which promote the binding process of the components. This includes specificity enhancing substances like the above mentioned conjugates; but also substances which modify the sample properties such that the binding of the components to the surface is facilitated. When nucleic acids are used these are chaotropic salts such as guanidinium isothiocyanate, guanidinium hydrochloride, sodium iodide, sodium perchlorate or the like. Chaotropic salts of this kind are known from Anal. Biochem. 121, 382-387 (1982) and DE-A 3734442. Apart from facilitating binding, guanidinium isothiocyanate also helps lyse the cells, bacterial cells and viral particles, and protects nucleic acids from degradation by inactivating RNases and DNases present in sample materials such as whole blood, serum etc.

The lysis reagent formulation can also contain reagents which convert the components into a form which basically enables a binding process. This includes reagents to lyse compartments, e.g. cells, which contain nucleic acids. Such a reagent is, for example, proteinase K or the above chaotropic salts.

Furthermore, the formulation comprises excipients that promote tablet formation. Such excipients can be excipients useful for direct-compression of tablets. It is, however, important to choose excipients which do not interfere with the subsequent analysis of the analyte. Excipients that may be comprised in said lysis reagent formulation are commonly used tabletting excipients, such as compression aids, flow aids, lubricants or diluent binders which are advantageous during the tabletting process.

Preferably, said excipient is a lubricant. Lubricants are advantageous during the tabletting process. Lubricants suitable for tablets comprising magnetic particles and chaotropic salts are lubricants which facilitate subsequent binding of analytes during the sample preparation process and which also facilitate subsequent analysis of the analyte. Thus, the lysis reagent formulation according to the present invention comprises a lubricant which facilitates the formation of a tablet and binding of a binding component. Preferably, said lubricant is water soluble. More preferably, said lubricant is sodium benzoate. Preferred amounts of the lubricant hereinbefore described in the tablet are 0.5 to 2 weight %.

The term “facilitate binding” as used herein means that the excipient does not inhibit binding, but allows binding of components to magnetic particles to occur.

In another preferred embodiment of the excipient which facilitates binding of components, the excipient is a mannitol. In a preferred embodiment, said mannitol is Pearlitol, more preferably Pearlitol 100 SD. These excipients are diluent-binders which are useful for direct-compressing of tablets.

The lysis reagent preparation can also contain pH buffer substances and reagents for dissolving links such as hydrogen bridges, hydrophobic and ion links as well as reagents for the specific detection of substances or indicators as they are known with components of immunoassays.

The tablet of the invention can of course also contain other components, e.g. inert filling agents; the total amount adds up to 100%. The percentages given are weight percentages.

The lysis reagent formulation of the invention in the form of a tablet can be manufactured corresponding to other drugs in tablet form. To accomplish this, all necessary components are thoroughly mixed and aliquots are tabletted in a tablet press. This is accomplished in particular by applying pressure. Thus, the present invention also relates to a method of preparing a lysis reagent formulation as described hereinbefore, comprising the steps of

a) mixing magnetic particles, a chaotropic salt and an excipient and
b) compressing the mixture obtained in step a). The mixture of step a) may be granulated prior to compression. Preferably, said tablet is prepared by direct-compression. Preferably, said excipient is a lubricant which facilitates tablet formation and binding of components of a sample. Preferred embodiments of said lubricant are as described hereinbefore. In another preferred embodiment, said excipient is a mannitol, more preferably Pearlitol, most preferably Pearlitol 100 SD. Preferred embodiments of magnetic particles, and chaotropic salt are as described hereinbefore.

These manufacturing processes entail a very low coefficient of variation of the tablet weight and hence a high reproducibility when dosing the reagent in the practice. Erroneous dosing is then reduced and easier to trace back. The tablets of the invention can be rapidly dissolved, preferably in less than 30 sec., particularly preferred in less than 1 to 10 sec. while the magnetic particles can be easily and readily dispersed. Tablet form is also expedient with respect to storage. Dosing can even be accomplished manually with the aid of a tablet dispenser. Adulterations which occur in suspensions and are caused by sedimentation of particles have not been observed.

Another subject matter of the invention is the use of the lysis reagent formulation for binding nucleic acids. To accomplish this, the lysis reagent formulation is added to the sample and incubate until (1.) the tablet has dissolved and (2.) the nucleic acids are essentially completely bound to the surface. The tablet can be mechanically moved, if necessary. This increases both the dissolving rate of the tablet and the binding rate of the components.

Another subject matter of the invention is the use of the lysis reagent formulation for purifying nucleic acids. To achieve this, the magnetic particles and the nucleic acids bound thereto are separated from the surrounding sample liquid. This is advantageously accomplished in that a magnetic field is applied to retain the magnetic particles in a vessel or at a defined site of the apparatus; then the sample liquid is removed (by e.g. pipetting or displacement) and, if desired, one or several washing steps with other liquids are performed. If desired, the bound nucleic acids can be separated again from the magnetic particles when suitable conditions are applied. In the case of a glass-like surface, these are low-salt conditions, i.e. the salt contents of the elution solution is less than 100 mmol/1.

Another subject matter of the invention is a method of preparing a suspension magnetic particles in a sample comprising the steps of a) adding the reagent formulation containing magnetic particles, chaotropic salt and a which can facilitate binding of components to a sample, and b) moving the tablet in sample, preferably with the aid of a movable magnetic field. In a preferred embodiment, a detergent is added before or after step a). More preferably, said detergent is CHAPS. The magnetic field can be moved in that a magnet in the vicinity of the sample is moved back and forth such that the magnetic particles are subject to continuous movement. It is, however, also possible that the vessel containing the sample with the tablet and the magnetic particles is moved with respect to the magnet. Preferred embodiments of magnetic particles, chaotropic salt, and excipient which can facilitate binding of components are as described hereinbefore.

Yet another subject of the invention is a method of incorporating magnetic particles in a sample comprising the steps of providing a dispenser which contains a multitude of magnetic particle-containing tablets and activating the dispenser to release a tablet. Dispensers for providing tablets are commonly used when administering drugs in the form of tablets. They can be used manually for dosing procedures in the method of the invention. It is not absolutely necessary to release only one tablet per sample. It is also possible to release a defined number of tablets, e.g. between 2 and 10, depending on the intended use in the sample.

### EXAMPLES

The following example is provided to aid the understanding of the present invention, the true scope of which is set forth in the appended claims. It is understood that modifications can be made in the procedures set forth without departing from the spirit of the invention.

### Example 1

### Preparation of the Glass Magnet Pigment

The parameters used in the preparation of the glass magnetic pigment are summarized in Table 1.

A sol (SiO₂:B₂O₃=7:3) was prepared in a 250 ml round flask under constant stirring while observing the following instructions

86.6 ml tetraethylorthosilicate
+7 ml anhydrous, non-denatured ethanol

### +14 ml 0.15 M HCl

A two-phase mixture is obtained which is stirred at room temperature until one single phase is obtained. Then 37.8 ml trimethylborate are added dropwise. Subsequently the sol is for 2 hours kept at a temperature of 50° C. Then, 14.1 ml of 15 M HCl are added.

After maturing, 22.5 g Iriodin 600 (Black Mica, Merck, Darmstadt, Germany) were added to 150 ml sol under stirring and then coated with a spray-drier (Buchi 190, Mini Spray Dryer).

The powder obtained in the spray-drying process was then subject to temperature treatment under a nitrogen atmosphere. The heating rate was 1 K/min and the dwelling time was 2 hours at the compacting temperature. After compacting, the temperature was lowered down to the temperature of the follow-up treatment; the nitrogen atmosphere was replaced by air and after the follow-up treatment, the powder was cooled down to room temperature. Agglomerates that may have formed were removed by sieving with a 50 μm sieve.

TABLE 1
Parameters used in the preparation of the glass magnetic pigment

| Parameter | GMP 2 |
|---|---|
| Maturing of the sol at 30° C. (h) | 36 |
| Percentage of pigment of the sol (g/100 ml) | 15 |
| Nozzle temperature (° C.) | 120 |
| Air current of nozzle (%) | 100 |
| Air pressure (bar) | 6 |
| Compacting temperature (° C.) | 534 |
| O₂ Follow-up treatment (1 hour) | (300° C.) |

### Example 2

### Tablet Production

Ingredients according to table 2 were mixed and compressed directly, without granulation step. Lack of lubricant caused the tablet press to jam.

TABLE 2
Ingredients in magnetic glass pigment

| | Batch 1 | Batch 2 | Batch 3 |
|---|---|---|---|
| GuSCN, mg | 330 | 330 | 330 |
| MGP, mg | 6 | 6 | 6 |
| NaCl, mg | 84 | 82 | 76 |
| Sodium Sterylfumerate, mg | 0 | 2 | 0 |
| Sodium Benzoate, mg | 0 | 0 | 8 |
| Total, mg | 420 | 420 | 420 |
| # of Tablets | 3000 | 1400 | 4150 |
| Tablet Hardness, N | 45 | 38 | 42 |

### Example 3

### Protocol for Sample Prep with Tablet on EpMotion

The whole sample preparation process was performed with plasma on the epMotion (Eppendorf). 850 μl sample were transferred from the primary tube into a processing plate (in this case a 96-deep-well-plate). Tablets as well as 26 mg CHAPS (detergent) and 6.5 mg DTT (reducing agent) were pre-aliquoted to the single wells. The tablets contained 330 mg GuSCN so that a concentration greater than 2M GuSCN in the final lysis reaction was reached. Additionally the tablets contained 6 mg magnetic glass particles, 76 mg NaCl as excipient and 8 mg sodium benzoate as lubricant. The Tablet and the other lysis components were dissolved by sip-and-spit mixing until tablet was dissolved. Subsequently 5 mM-Citrate, 100 μl of the internal control (IC) and 50 μl of the protease reagent were transferred to the lysis reaction. The solution was mixed and incubated at 37° C. for 15 min. After the incubation the MGPs were separated from the lysis solution by a magnet. The lysis solution was aspirated and discarded. The MGPs were washed twice with 1.5 ml of a low pH Wash Buffer (7.5 mM sodium citrate, pH 4.1). After each washing step the used Buffer was aspirated and discarded. After the washing procedure the nucleic acids were eluted from the magnetic glass particles in 55 μl of a high pH, low salt-concentration buffer (30 mM Tris, pH 8.5) for 8 min at 80° C. The eluate was used for further analysis, preferably for RT-PCR.

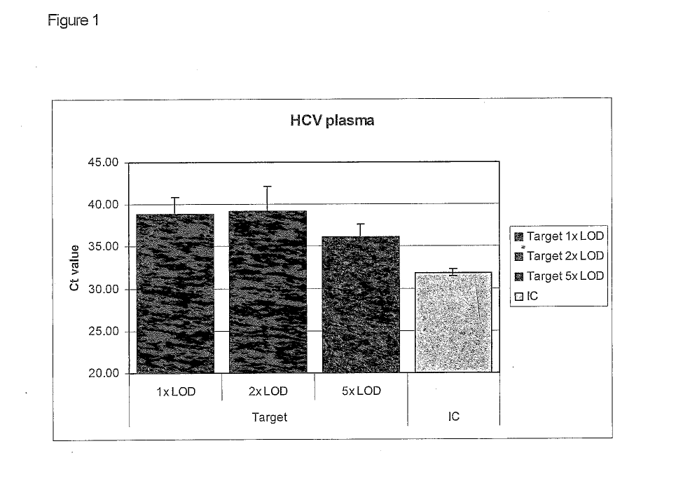

Assay Performance with Tablet in DWP on epMotion and AD (Amplification/Detection) on CTM (Cobas TaqMan) with MPX v1.0 Mastermix reagents is shown in FIG. 1. Sample Preparation process was as described above. HCV Target was diluted in Plasma at different concentrations: 1×LOD (10.7 IU/ml), 2×LOD (21.4 IU/ml) and 5×LOD (53.5 IU/ml). LOD is Limit of Detection.

The Limit of Detection is stated in the product manual and says' that the used test can detect RNA at concentrations of 1×LOD (e.g. 10.7 IU/ml for HCV in Plasma) or at greater concentrations with a positivity rate of □ 95%.

### Example 4

### Influence of Tablet Excipients on Assay Performance

Sample Preparation and AD (amplification and detection) were performed on the CAP-CTM (Cobas AmpliPrep-Cobas TaqMan) using TaqScreen MPX v1.0 reagents (commercially available from Roche, Mat# 04584244190) and the appropriate sample prep method. Target HCV and HBV at 100 IU/ml and HIV at 100 cp/ml diluted in Plasma. Results are shown in table 3.

TABLE 3
Amplification and detection of viral templates

| | HIV | | HBV | | HCV | | IC* | |
|---|---|---|---|---|---|---|---|---|
| | Average | | Average | | Average | Hit | Average | |
| Excipient | Ct | Hit Rate | Ct | Hit Rate | Ct | Rate | Ct | Hit Rate |
| none | 32.4 | 4/4 | 29.7 | 4/4 | 33.4 | 4/4 | 31.5 | 12/12 |
| sodium- | na | 1/4 | na | 1/4 | na | 1/4 | na | 5/12 |
| Stearylf. 2% | | | | | | | | |
| sodium- | na | 0/4 | na | 0/4 | na | 0/4 | na | 0/12 |
| Stearylf. 4% | | | | | | | | |
| sodium- | 33.1 | 4/4 | 30.2 | 4/4 | 33.8 | 4/4 | 31.4 | 12/12 |
| Benzoate 2% | | | | | | | | |
| sodium- | 33.1 | 4/4 | 30.1 | 4/4 | 33.9 | 4/4 | 31.4 | 12/12 |
| Benzoate 4% | | | | | | | | |

*Internal control

### Example 5

Sample preparation and AD were performed as in Example 4, however, Pearlito1100 SD was used instead of sodium benzoate. Pearlitol is a mannitol which is a diluent-binder useful for direct-compression of tablets. Results are shown in Table 4.

TABLE 4
Amplification and detection of viral templates

| | HIV | | HBV | | HCV | | IC* | |
|---|---|---|---|---|---|---|---|---|
| | Average | | Average | Hit | | Hit | Average | Hit |
| | Ct | Hit Rate | Ct | Rate | Average Ct | Rate | Ct | Rate |
| w/o | 32.4 | 4/4 | 29.7 | 4/4 | 33.4 | 4/4 | 31.5 | 12/12 |
| sodium- | na | 1/4 | na | 1/4 | na | 1/4 | na | 5/12 |
| Stearylf. 2% | | | | | | | | |
| sodium- | na | 0/4 | na | 0/4 | na | 0/4 | na | 0/12 |
| Stearylf. 4% | | | | | | | | |
| Pearlitol 2% | 32.7 | 4/4 | 29.9 | 4/4 | 33.5 | 4/4 | 31.7 | 12/12 |
| Pearlitol 4% | 33 | 4/4 | 30.2 | 4/4 | 33.5 | 4/4 | 31.6 | 12/12 |

*Internal control

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

We claim:

1. A lysis reagent formulation in the form of a tablet for binding components of a sample, comprising
a. a multitude of magnetic particles having a surface to which the components can essentially completely bind,
b. a chaotropic salt, and
c. an excipient which facilitates the formation of a tablet and binding of said binding component, wherein said excipient is a water soluble lubricant.

2. The lysis reagent formulation according to claim 1, wherein said lubricant is sodium-benzoate.

3. The lysis reagent formulation according to claim 1, wherein the magnetic particles have a glass-like surface.

4. The lysis reagent formulation according to claim 1, wherein the tablet is heavier than 5 mg.

5. The lysis reagent formulation according to claim 1, wherein the chaotropic salt is GuanidineSCN.

6. A method of preparing a lysis reagent formulation according to claim 1, comprising the steps of
a) mixing magnetic particles, a chaotropic salt and an excipient
b) compressing the mixture obtained in step a).

7. The method according to claim 6, wherein said excipient is a lubricant which facilitates tablet formation and binding of components of a sample.

8. A method of preparing a suspension of magnetic particles in a sample, comprising the following steps
adding the lysis reagent formulation according to claim 1 containing magnetic particles, chaotropic salt and an excipient to a sample, and
moving the tablet in the sample.

9. The method of claim 8, additionally comprising, before or after step a), adding a detergent.

10. The method of claim 9, wherein said detergent is CHAPS.
